(19) United States
(12) Patent Application Publication
(10) Pub. No.: US 2021/0319221 A1
(43) Pub. Date: Oct. 14, 2021

(54) Vessel Height Detection Through Video Analysis

(71) Applicant: NCS Pte. Ltd., Singapore (SG)

(72) Inventors: Huanliang SUN, Singapore (SG); Yu ZHANG, Singapore (SG)

(21) Appl. No.: 17/252,316

(22) PCT Filed: Jun. 28, 2018
(86) PCT No.: PCT/SG2018/050314

§ 371 Date: Dec. 15, 2020

(30) Foreign Application Priority Data
Jun. 28, 2018 (SG) PCT/SG2018/050314

(51) Int. Cl. G06K 9/00; G06K 9/32; G06K 9/62

(52) U.S. Cl. CPC G06K 9/00671; G06K 9/6211; G06K 9/3233

(57) ABSTRACT

A vessel detection and height measurement system may use a video camera to identify a marine vessel and measure the vessel's height. The system may identify vessels moving into an area of interest, then train a video camera on the vessel. The video feed may be analyzed to identify the vessel of interest, then a height measurement may be taken. The video camera may be located on a surveyed location and the field of view may be calibrated using several surveyed locations within the field of view. The vessel may be identified using radar or other systems, and the vessel's position, speed, and movement direction may be used to determine where to look for the vessel using the video camera, as well as to identify which movements detected in the video feed correspond with the vessel of interest.

### CROSS REFERENCE TO RELATED APPLICATIONS

This patent application is the national stage entry of PCT/SG2018/050314, “Vessel Height Detection through Video Analysis” filed 28 Jun. 2018 by NCS Pte. Ltd., the entire contents of which are hereby expressly incorporated by reference for all they disclose and teach.

### BACKGROUND

Marine vessels have for centuries been quite tall. From the wooden whaling ships of old to today's modern containerized freighters, the height of the vessels can be a problem near shore. One area of concern is the height of vessels near airports.

The approach and departure paths for airports may include very low flying aircraft near bodies of water. Many modern airports are being constructed near water, often on reclaimed land, and such airports are typically very close to sea level. Cities with airports near water often have ports, which means the chances of interactions between low flying aircraft and large marine vessels can be a large concern.

### SUMMARY

A vessel detection and height measurement system may use a video camera to identify a marine vessel and measure the vessel's height. The system may identify vessels moving into an area of interest, then train a video camera on the vessel. The video feed may be analyzed to identify the vessel of interest, then a height measurement may be taken. The video camera may be located on a surveyed location and the field of view may be calibrated using several surveyed locations within the field of view. The vessel may be identified using radar or other systems, and the vessel's position, speed, and movement direction may be used to determine where to look for the vessel using the video camera, as well as to identify which movements detected in the video feed correspond with the vessel of interest.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an example embodiment showing a video system being used for vessel height detection.

FIG. 2 is a diagram illustration of an embodiment showing a network environment with a vessel height analysis system.

FIG. 3A is an example illustration showing a video feed and blobs detected on the video feed.

FIG. 3B is a second example illustration showing a video feed and blogs detected on the video feed.

FIG. 4 is a flowchart illustration of an embodiment showing a method for identifying vessels for height analysis.

FIG. 5 is a flowchart illustration of an embodiment showing a method for processing a video feed for blob identification.

FIG. 6 is a flowchart illustration of an embodiment showing a method for determining a vessel height from a video feed.

FIG. 7 is a flowchart illustration of an embodiment showing a method for calibrating a video camera for pan tilt angle.

### DETAILED DESCRIPTION

Vessel Height Detection Through Video Analysis

Overall Process

A vessel's height may be determined by analyzing a video feed of vessel movement in a waterway or near shore. The video may be taken from a known location on shore using a fixed or moveable video camera. By identifying a moving vessel within the video feed that corresponds with the known position, speed, and movement direction, a height measurement of the vessel may be calculated.

The system for measuring vessel height may achieve accuracies of +/−1 m over a 6 Km range. Such an accuracy may be sufficient to accurately determine vessel height encroachments on airport approach and departure paths.

The system may identify vessels entering an area of interest, then analyze the vessel's height. If a tall vessel may be entering an airport approach or departure path, an alert may be generated to inform both the local waterway authorities and the airport authorities of a potential incursion in the paths of airplanes. Such a system may be automatic, such that detection, height measurement, and incursion detection may operate without human input.

A marine radar system may monitor the movements of vessels in a waterway or near shore. Such systems may generate a specific identifier for the vessel, as well as rather accurate position information. In some cases, the radar system may also provide a speed and direction for the vessel.

The marine radar system may identify vessel movements into an area of interest. As the vessels enter the area of interest, an alert may be generated to cause a system to measure the vessel height. If the vessel height is above a certain threshold and the vessel may appear to enter a restricted area, a warning may be issued to the authorities for marine or aircraft movement.

The restricted area may be a designated flight path for approaches or departures from a nearby airfield. The area of interest may be substantially larger, such that vessels that enter the area of interest may be measured and, if they pose a problem with airplane flight paths, may be contacted and advised to change route prior to intruding on the potential flight paths.

Video Analysis Process

Analyzing video to determine a vessel's height can be very complex. A typical video of marine traffic may have several vessels in view, not to mention the complexities of movement of birds, waves, trees, and other objects in a field of view. Compounding the complexities are weather, darkness, and other factors.

In order to accurately identify the vessel of interest from different moving items in a video stream, the video may be analyzed by identifying moving blobs within the video picture, then removing blobs that do not move in a manner expected of the vessel. Blob analysis may be performed by identifying objects that may change position from one frame to another.

One of the complexities of video analysis can be that marine vessels may move slowly relative to the frequency of video frames. Such can be the case for very large vessels, which tend to be some of the tallest and therefore more interesting for detecting. For slower moving vessels, only slight movement may be detected from one frame to the next, and such vessels may be detected using frames that are 0.1 second apart, or even 1, 2, 5, 10, or more seconds apart.

As a video analysis may begin, blobs may be recognized by analyzing a sequence of frames to identify groups of pixels within the image that move together. Each blob may be tracked for a period of time before the blob may be identified. Such a period may eliminate certain effects that may appear to be motion while the effect may be the oscillation of trees, waves, or other effects.

The blobs of interest may be those that may correspond with the expected movement of the vessel. Because the location of the vessel may be known from radar, as well as the speed and movement direction, the expected behavior of a vessel's blob may be calculated. Blobs that behave in the expected manner may be grouped together as possibly representing the vessel of interest. Such a technique may combine video data with data from a secondary source, such as radar, to determine which movement in a video stream may be of interest for analysis.

In many cases, a camera may be mounted inland. As such, some cameras may routinely include buildings, tress, and other land-based obstacles in various fields of view. When such a condition exists, a system may construct a video mask for removing those areas of a field of view where land-based or other stationary objects may exist. Such a mask may remove areas of the video that may consume processing power to analyze, where those areas may not be able to assist in identifying a vessel of interest.

Once the blob of interest may be identified, a height calculation may be performed by identifying the highest pixel of the blob and calculating a height, since the distance from the camera to the vessel may be known.

Video Alignment and Accuracy

The accuracy of a height measurement is dependent on the accuracy of the angle of the pan tilt. The system accuracy can be +/−1 m over 6+km, provided that the accuracy of the pan tilt angle is known to an accuracy of 0.01 degree or better. In general, mechanical leveling of a video camera may be accurate only to 0.1 degree.

One method for determining the pan tilt angle may be to calibrate the video camera using surveyed markers or surveyed points that may be viewable from the camera. In many cases, a video camera may be mounted on a pan mechanism that may be positioned where the camera may pan 180 degrees or more. Over such a wide area, many systems may use multiple calibration points, such as many as 5 or 10 surveyed points. The surveyed points may have a known distance from the camera and vertical height to centimeter accuracy in many cases.

A method for aligning the video camera may be to initially install the camera and level the pan mechanism to within 0.1 degree using conventional bubble leveling equipment. Once the video camera has been installed, a video image may be generated by pointing the camera towards each surveyed point and calculating the pan tilt angle for each point.

Some systems may use a camera with a computer-controlled pan angle adjustment. Such camera systems may be able to tilt up and down when focusing on a surveyed point, then return a tilt angle that may be measured from horizontal.

Once several points have been collected, a function may be developed that may return the actual pan tilt angle for a given pan angle input. A regression algorithm may be used to determine such a correlation between measured pan tilt angle using the surveyed markers and an arbitrary pan angle within the operational limits of the camera.

The system may use a video camera that may be aligned to point in a level manner, and may pan from one angle to another under computer control, and some systems may further include a controllable tilt angle that may allow the camera to tilt with respect to horizontal. In a typical use case, the camera may be mounted on a building, tower, or other structure at a predefined height above sea level. In such a mounting position, the camera may have a field of view that may have a vertical center close to the horizon. Such a mounting position may typically show a vessel from the waterline to its highest point.

Throughout this specification, like reference numbers signify the same elements throughout the description of the figures.

In the specification and claims, references to “a processor” include multiple processors. In some cases, a process that may be performed by “a processor” may be actually performed by multiple processors on the same device or on different devices. For the purposes of this specification and claims, any reference to “a processor” shall include multiple processors, which may be on the same device or different devices, unless expressly specified otherwise.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

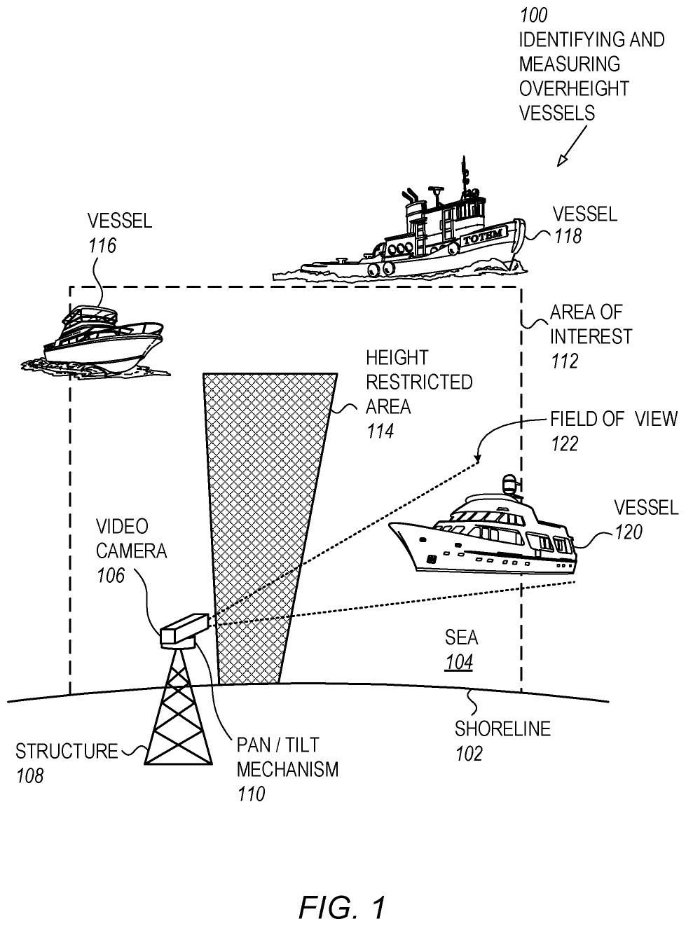

FIG. 1 is a diagram illustration showing embodiment 100, a system for identifying vessels and determining their heights. Embodiment 100 may be deployed near an airport to detect marine vessels that may impede the flight path of approaching or departing aircraft.

The illustration shows a shoreline 102 and sea 104, where a video camera 106 may be mounted on a structure 108. The video camera 106 may have a pan mechanism 110, which may allow the camera 106 to pivot laterally to capture video across the area of interest 112. The video camera 106 may also have a controllable tilt angle, where the camera's tilt from horizontal may be changed and measured.

The area of interest 112 may be a shipping channel or other body of water near an airport. For many major cities on a coastline, both air and marine traffic may make up a large portion of the economy. Since airports tend to be noisy and have height restrictions near the runways, airports are often constructed near the water. This juxtaposition of the airport near the water can cause potential problems when shipping vessels may pass near the end of the runways.

An area of interest 112 may expand past a height restricted area 114, which may represent a region of low flying aircraft. In the area of interest 112, several vessels 116, 118, and 120 are illustrated. Marine vessels in a busy port may be monitored by ground-based radar that may operate with transceivers on the vessels to identify the ships and provide other information.

In a typical detection system, a marine radar system may monitor a waterway and determine that a vessel may be entering the area of interest 112. As the vessel enters the area of interest 112, the vessel's position, speed, and direction may be transmitted to a height analysis system. The information about the vessel may also include the vessel's name and other identifiers, as well as other information about the vessel.

A height analysis system may train the video camera 106 towards a vessel. In the example of embodiment 100, the video camera 106 may be positioned to have a field of view 122 that may capture the vessel 120. By knowing the position of the vessel 120 with respect to the position, the tilt angle of the camera from horizontal, and height of the video camera 106, a video feed may be analyzed to identify the height of the vessel 120.

When a system detects that an over height vessel may be nearing the height restricted area 114, alerts may be transmitted to marine and air traffic controllers. Marine controllers may attempt to instruct the vessel to avoid the height restricted area, while aircraft controllers may alert inbound or outbound aircraft of the collision danger posed by the vessel.

In order to automate the vessel height measurement, the video feed from the video camera 106 may be analyzed. The video camera 106 may be pointed in a fixed direction, then the video may be monitored to identify movement in the images. The movements may be identified as blobs of pixels that change position from one image to another.

The blobs that may be captured may be quite noisy. Since many of such systems may monitor 5-10 km away from shore, reflections of waves, other vessels, birds, trees, and other objects may provide false positive indicators of movements. Further, the video may be captured at different times of day or night and in all weather conditions.

One method to identify a blob that may represent a vessel is to estimate the movement of a vessel's blob within the video stream. For example, a blob may be expected to move from right to left at a certain speed. By eliminating blobs that do not show the expected motion, many of the blobs may be filtered out.

A height measurement may be performed through an iterative process. A relatively wide angle video image of a vessel may be used to identify the vessel of interest, then the camera may be zoomed in near the highest portion of the blob to capture a more accurate reading of the height. In some cases, the process may be repeated with a third or even fourth image, where each image may be zoomed in even further on the highest element of a vessel.

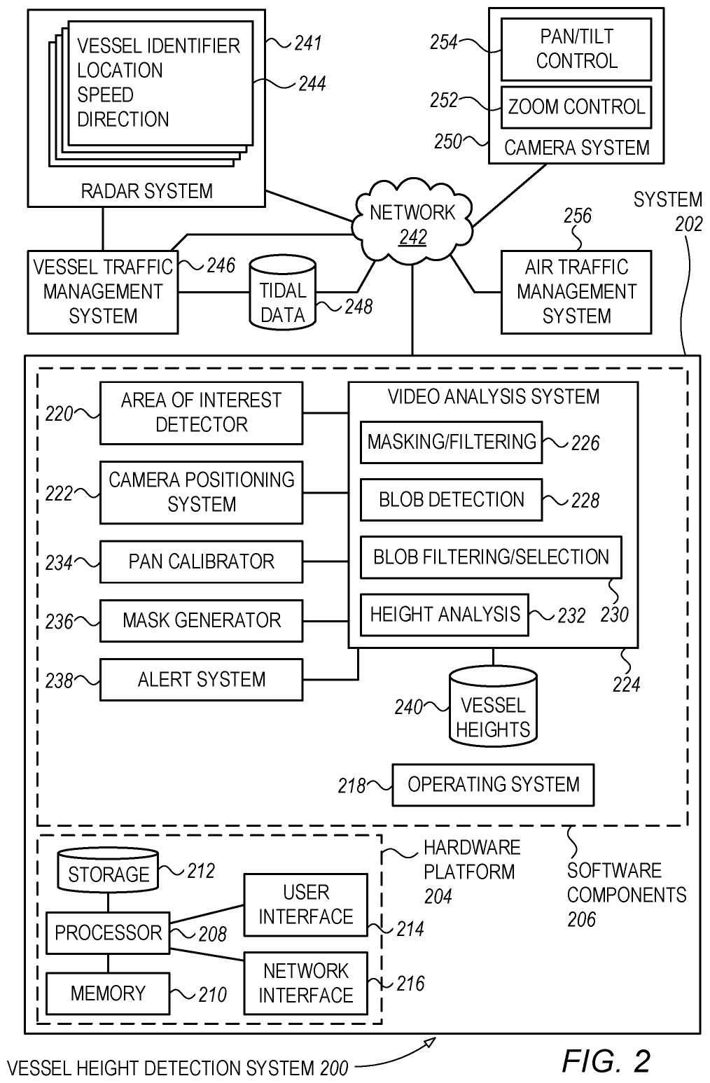

FIG. 2 is a diagram of an embodiment 200 showing components that may automatically detect vessel heights and send alerts when high vessels encroach into a predefined area. Embodiment 200 is merely one example of a network environment where a marine radar system, a vessel height detection system, and various other components may operate.

The diagram of FIG. 2 illustrates functional components of a system. In some cases, the component may be a hardware component, a software component, or a combination of hardware and software. Some of the components may be application level software, while other components may be execution environment level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 200 illustrates a system 202 that may have a hardware platform 204 and various software components. The system 202 as illustrated represents a conventional computing device, although other embodiments may have different configurations, architectures, or components.

In many embodiments, the system 202 may be a server computer. In some embodiments, the system 202 may still also be a desktop computer, laptop computer, netbook computer, tablet or slate computer, wireless handset, cellular telephone, game console or any other type of computing device. In some embodiments, the system 202 may be implemented on a cluster of computing devices, which may be a group of physical or virtual machines.

The hardware platform 204 may include a processor 208, random access memory 210, and nonvolatile storage 212. The hardware platform 204 may also include a user interface 214 and network interface 216.

The random access memory 210 may be storage that contains data objects and executable code that can be quickly accessed by the processors 208. In many embodiments, the random access memory 210 may have a high-speed bus connecting the memory 210 to the processors 208.

The nonvolatile storage 212 may be storage that persists after the device 202 is shut down. The nonvolatile storage 212 may be any type of storage device, including hard disk, solid state memory devices, magnetic tape, optical storage, or other type of storage. The nonvolatile storage 212 may be read only or read/write capable. In some embodiments, the nonvolatile storage 212 may be cloud based, network storage, or other storage that may be accessed over a network connection.

The user interface 214 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 216 may be any type of connection to another computer. In many embodiments, the network interface 216 may be a wired Ethernet connection. Other embodiments may include wired or wireless connections over various communication protocols.

The software components 206 may include an operating system 218 on which various software components and services may operate.

An area of interest detector 220 may identify vessels that may be entering an area of interest. In many cases, a virtual “tripwire” may designate a boundary in which vessel's heights may be checked. Vessels outside the boundary may not affect a height-restricted area and therefore may not be checked.

The area of interest detector 220 may receive a list of vessels from a radar system 241, which may be connected to the system 202 through a network 242. The radar system 242 may transmit a notice 244 containing a vessel identifier as well as the vessel's location, speed, and direction. In some cases, the notice 244 may also include other information about the vessel, such as the destination of the vessel, vessel type, amount of cargo, and other information.

The radar system 241 may be part of a navigational system used by marine terminal controllers to monitor and control ship movements near a port. Such systems may generate relatively accurate positional data for each vessel, and may work in conjunction with a vessel traffic management system 246. Some systems may integrate with an Automatic Identification System (AIS), including satellite AIS, which is an international standard system for tracking marine vessels.

When a vessel has been identified for height measurement, a camera positioning system 222 may transmit pan and zoom information to a camera system 250. The camera system 250 may be mounted on a fixed location on land, positioned such that a video camera may view vessels in a waterway. The camera system 250 may have a pan/tilt control 254 and a zoom control 252, all of which may receive commands from the camera positioning system 222.

The camera positioning system 222 may receive the vessel's position and may calculate a pan angle, tilt angle, and zoom factor for positioning the camera. The appropriate commands may be transmitted to the camera system 250 so that the camera may collect video images that capture a vessel of interest.

A video analysis system 224 may process the video feed to calculate the height of the vessel. A masking or filtering system 226 may provide a mask to the video to block out portions of a viewable image that contain landside objects that may interfere with the image. For example, a mask may remove trees, roads, or other landside objects that may interfere with the video feed. Many such objects may move during a video image and produce movement blobs that may be false positives. Buildings and other fixed objects may also be masked.

A blob detection system 228 may identify movement in a video feed. A blob may be a group of pixels that may move together from one frame to another. A blob detection system 228 may identify movement between frames, and may continue to monitor movement through successive frames. Because the blobs of interest may represent a vessel, blobs that may appear for a short period of time and disappear may be discarded. In many cases, a blob detection system 228 may have a minimum threshold, such as 20 frames, 10 seconds, or some other metric, where blobs that do not exist for the minimum threshold may not be considered for further analysis.

A blob filtering and selection system 230 may determine which blobs, if any, may represent the vessel of interest. Since the radar system 242 may have provided the vessel's position as well as speed and direction, an expected movement vector may be established for a blob representing the vessel of interest. Such a filter may remove blobs of other ships, birds, airplanes, or other objects that may not be moving in the expected direction. The remaining blobs that move in the expected manner may be consolidated into a blob representing the vessel of interest.

A height analysis system 232 may determine the vessel's height. The height may be determined through image analysis, since the height and position of the camera may be known as well as the relative position of the vessel. The height may be measured as the top pixel of a blob representing the vessel of interest.

In some cases, a height analysis system 232 may iterate on the blob of interest to determine an accurate height. For example, a first blob representing a vessel may be identified and measured. The camera may be zoomed in on the blob near its highest point and the process may be repeated for capturing video and identifying blobs that may represent the vessel. At higher zoom positions, the accuracy of the height measurement may be increased dramatically. In some cases, a system may iterate two, three, or more times with increasing zoom factor to determine a vessel height more accurately.

The height analysis system 232 may determine two heights for the vessel. The measured height may be the height of the vessel above a fixed datum, such as mean sea level. A second height may be the air draft of the vessel, which may be the height of the vessel above the water. The air draft may be calculated using tidal data 248, which may have tide heights for the specific time a video may be captured. The air draft and other information may be stored in a vessel height database 240. The vessel height database 240 may be referenced to compare a previous height observation with a current height observation for a given vessel. In some cases, a previous measured height may be used as a substitute for a currently measured height when weather, time of day, or other factors may preclude taking a height measurement.

A pan calibrator 234 may calibrate the pan tilt angle of the camera system. Some height measurement systems may have an accuracy of +/−1 m at 6 km distance. In order to achieve such an accuracy, the parallelism or flatness of the camera's pan mechanism must be within +/−0.01 degrees or better. Such an accuracy may be determined by calibrating the video camera using several calibration points within the viewable area of the camera.

A calibration routine may cause the camera to point at a calibration point and take a height measurement of a predefined, surveyed point. The difference between the known height and the measured height may be an offset or error for that pan angle. By taking several such measurements, a function may be generated that may return an error factor for any pan angle across the viewable area of the camera.

A mask generator 236 may be a system that constructs a video mask that may remove landside objects from a video feed. A mask generator 236 may be an automated system that may scan the viewable area and detect fixed mounted objects as compared to water. In some cases, a mask generator 236 may be a manual or semi-automated system where a technician may manually identify the landside objects.

An alert system 238 may send alerts to a vessel traffic management system 246 and an air traffic management system 256 indicating that an over height vessel may be encroaching in a height restricted area. Information provided by the alert system 238 may assist maritime vessel controllers to give directions to an over height vessel to change course, as well as alert air traffic controllers of a possible obstruction for approaching or departing airplanes.

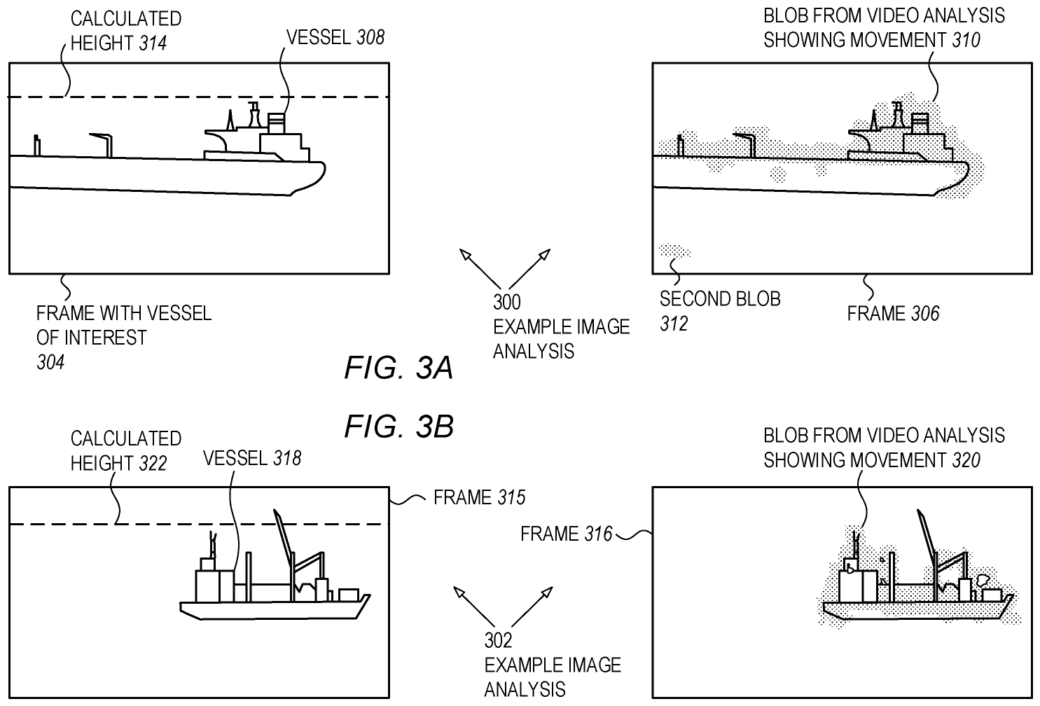

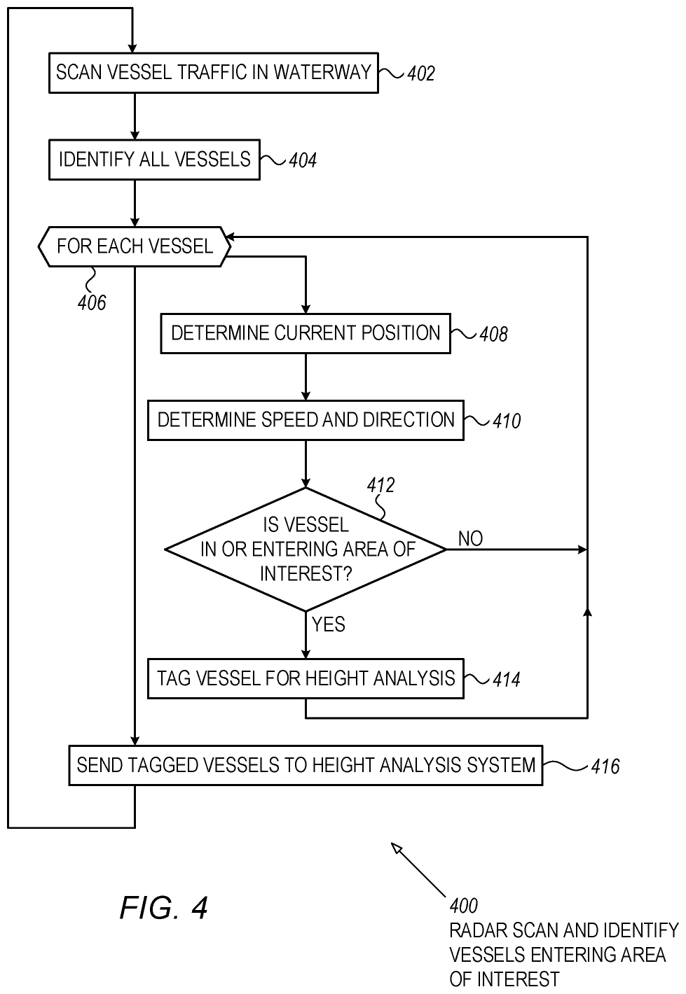

FIGS. 3A and 3B illustrate embodiments 300 and 302 showing video frames and blobs showing vessel movement. Each figure represents a separate vessel that may be analyzed for height.

FIG. 3A contains a frame 304 with a vessel of interest 308, as well as a frame 306 that includes a blob representing the vessel. From the blob analysis, a calculated height 314 of the vessel may be determined.

FIG. 3B contains a frame 315 with a vessel 318, as well as a second frame 316 with a blob 320 showing the vessel's movement. From the blob, a height 322 may be calculated.

FIGS. 3A and 3B represent a video analysis that detects a vessel's movement through a blob that changes across several video frames. The detected blob may be selected as the vessel because the blobs move in an anticipated direction and speed that may be consistent with the movement of the vessel. Frame 306 may contain a second blob 312, which may be a second ship moving in an opposite direction. Because the second blob 312 may not move in an anticipated direction, the second blob 312 may be removed from consideration.

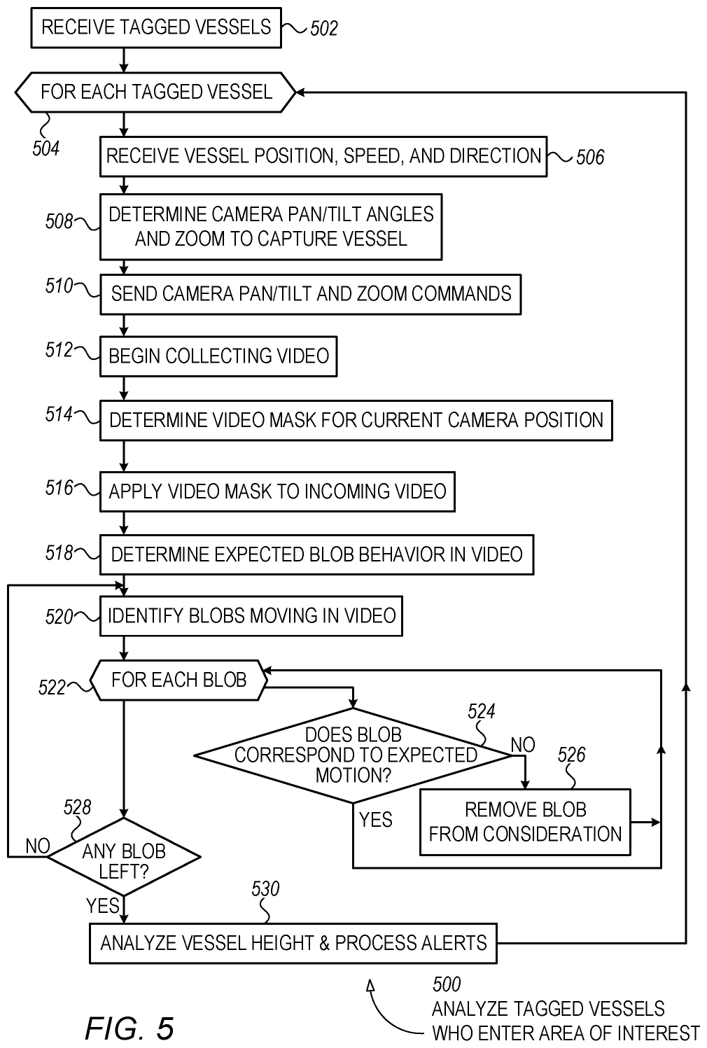

FIG. 4 is a flowchart illustration of an embodiment 400 showing a method of identifying vessels for height analysis. Embodiment 400 is a simplified example for a sequence that analyzes radar data from a shipping channel, then identifies potential vessels that may enter a restricted height zone. The vessel information may then be passed to a video analysis system for measuring the vessel's height.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

A radar system may scan vessel traffic in a waterway in block 402. The radar may identify all vessels in block 404, which are then processed in block 406.

For each vessel in block 406, a current position may be determined in block 408, as well as the vessel's speed and direction in block 410. From the position, speed, and direction, a calculation may be made to determine whether the vessel may be entering an area of interest. The area of interest may be positioned around a height restricted area such that a vessel that may encroach in the height restricted area may be warned to change course.

If the vessel is not entering an area of interest in block 412, the vessel is skipped and the process returns to block 406 to process another vessel. If the vessel is entering an area of interest in block 412, the vessel may be tagged for height analysis in block 414. After processing all the vessels in block 406, the list of tagged vessels may be sent to a height analysis system in block 416.

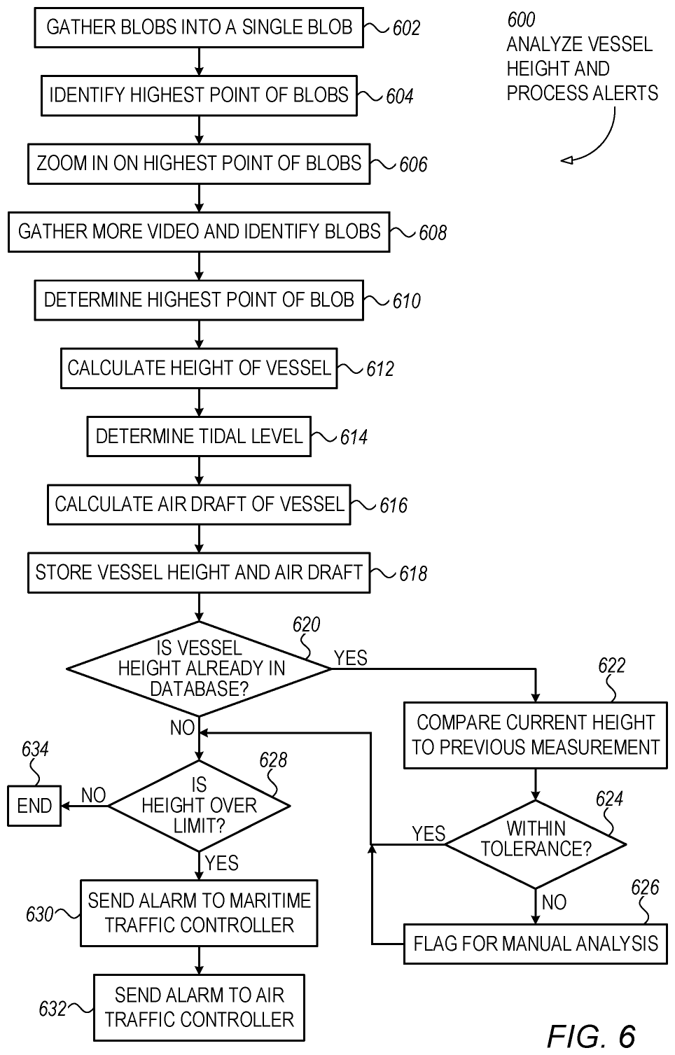

FIG. 5 is a flowchart illustration of an embodiment 500 showing a method of performing height analysis on vessels. Embodiment 500 is a simplified example for a sequence that uses video of a vessel to identify the vessel on the video, then take a height measurement.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

A group of tagged vessels may be received in block 502. A tagged vessel may include the vessel's position, speed, direction, as well as vessel identifiers, vessel type, and other information. Each tagged vessel may be processed in block 504 to determine its height.

For each vessel in block 504, the vessel's position, speed, and direction may be received in block 506. From the position information, a camera pan angle, tilt angle, and zoom may be calculated to capture a video image of the vessel in block 508. The commands to adjust pan/tilt and zoom may be transmitted in block 510, and video may be received in block 512.

A video mask may be determined for the camera position in block 514 and applied in block 516. A video mask may remove objects or areas from the video feed that may interfere or complicate detecting a video blob that may represent the vessel of interest. For example, a video mask may remove trees, buildings, landside roads and vehicles, and other objects that may not relate to the vessel of interest. By masking these object out of the video, blob detection may be simplified.

A calculation may be performed in block 518 to determine an expected blob behavior in the video image. The expected blob behavior may include the expected direction of movement and speed of movement. The calculation may convert physical speed and direction into speed and direction of blobs that may appear in the video image, which may be dependent on the pan angle and zoom factor.

Blobs may be identified in block 520. A blob may be identified by groups of pixels that change position from one frame to the next. Some blobs may be short lived and may only appear for a handful of frames, and in many cases, such blobs may be noise, such as water reflections, tree movements, and other motion. In many cases, a blob recognition routine may attempt to capture blobs that may persist for a period of time before being recognized.

For each blob in block 522, a screen may be performed to determine whether or not the blob moves in an expected motion in block 524. If the blob motion does not correspond with the expected motion in block 524, the blob may be removed from consideration in block 526. After processing all blobs in block 522, if no blobs are left in block 528, the process may return to block 520 to identify new blobs from the video. Such a situation may occur, for example, when a vessel may be difficult to detect, such as at nighttime or during poor weather conditions.

After processing the blobs and finding blobs that meet the expected movement within the video, the vessel height may be analyzed in block 530 and any alerts may be processed.

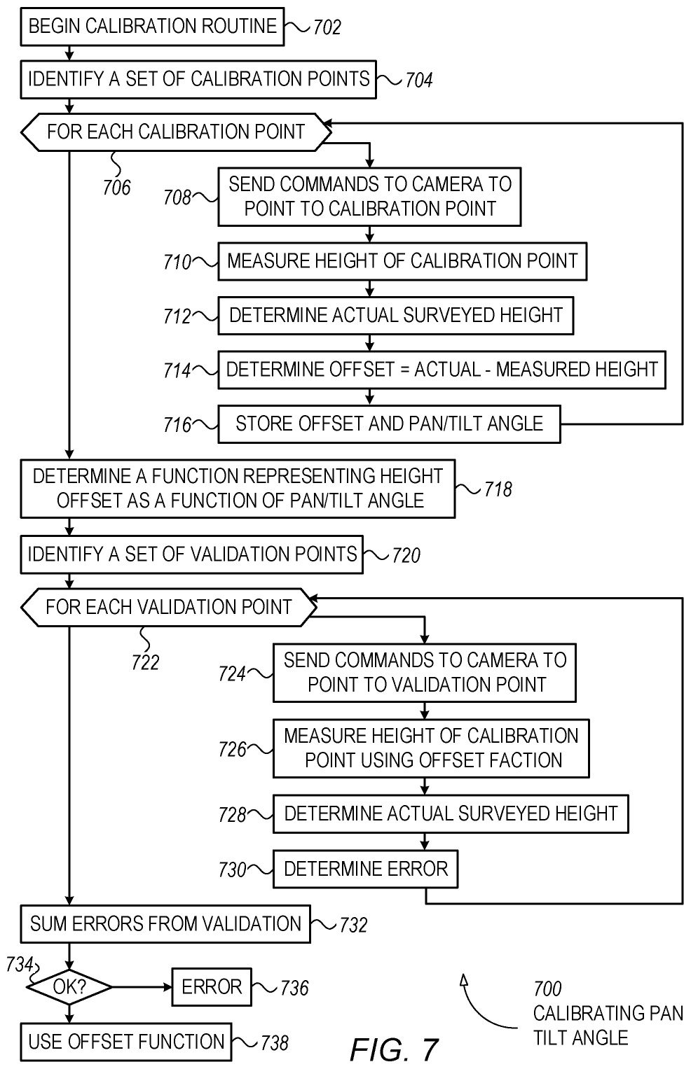

FIG. 6 is a flowchart illustration of an embodiment 600 showing a method of analyzing vessel heights and processing alerts. Embodiment 600 is a simplified example for a sequence that zooms into a blob to capture a more accurate height measurement, then stores height information. If an anomaly is detected, a height measurement may be flagged for manual analysis.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

The process of embodiment 600 may be performed as block 530 of embodiment 500.

The blobs identified in a video analysis may be consolidated into a single blob in block 602. In some cases, a blob analysis may identify several separate blobs that may represent a vessel, but may be separate groups of pixels. By consolidating the blobs into a single blob, the subsequent analyses may be performed.

The highest point of the blobs may be identified in block 604. At this point, a reasonably accurate height measurement may be made, but by zooming in on the highest point of the blobs in block 606 and gathering additional video in block 608, a more accurate height measurement may be made.

The highest point of the blobs captured from the zoomed-in video may be determined in block 610 and the height of the vessel may be calculated in block 612.

The height of the vessel may be a simple trigonometric calculation, where the height of the camera may be known, as well as the distance from the camera to the vessel. The angle from horizontal may be measured by measuring the number of pixels from center along with the zoom factor of the video image.

The tidal level may be determined in block 614, and using the calculated height from block 612, the air draft of the vessel may be determined in block 616. The air draft may be the height of the vessel from the waterline.

The vessel height and air draft may be stored in block 618. If the height and air draft is already in the database in block 620, the current measured height may be compared to the stored height in block 622. In some cases, the stored height may be a previous measurement of the vessel. In other cases, the stored height may be a declared height that a vessel may have provided prior to arrival.

If the two measurements are within a predefined tolerance of each other in block 624, the process may continue to block 628. If the current measured height and the previous measured height are different from each other more than a specified tolerance in block 624, the measurement may be flagged in block 626 for manual analysis.

A manual analysis may involve having a technician view the video and determine whether the video height measurement was accurate or not. In some systems, the technician may use a video system to manually identify the highest point of a vessel, which may cause the system to perform a height calculation using the technician's selected point.

If the height of the vessel is over a specified limit in block 628, an alarm may be sent to a maritime traffic controller in block 630 and an alarm may be sent to an air traffic controller in block 632. The various controllers may take appropriate action, such as instructing the vessel to change course or to alert air traffic to avoid the approach or departure areas affected by the vessel. If the height of the vessel is not above the limit in block 628, the process may end in block 634 with no alerts being sent.

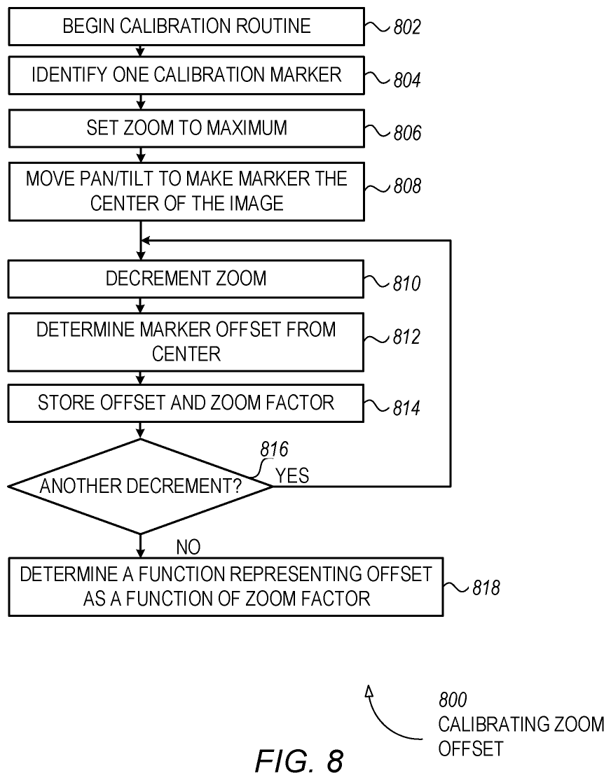

FIG. 7 is a flowchart illustration of an embodiment 700 showing a method of calibrating a video camera for pan tilt angle. Embodiment 700 is a simplified example of a sequence that uses a set of calibration points to determine a function that defines an offset for specific pan angles.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 700 is a method for calibrating a video camera that may be mounted on a pan/tilt swivel. In general, such as system when manually calibrated can achieve 0.1 degree accuracy. For measuring vessel heights at 6 km with +/−1 m accuracies, the pan tilt angle of 0.01 degree accuracy or better is desired.

A calibration routine may be begun in block 702. A set of calibration points may be identified in block 704. The calibration points may be physical locations within the viewable range of a video camera that may be surveyed. In many cases, the calibration point locations may be surveyed to +/−1 cm accuracies.

For each calibration point in block 706, a set of commands may be sent to the video camera to point to the calibration point in block 708. The height of the calibration point may be measured in block 710, and the actual surveyed height of the calibration point may be recalled in block 712. An offset may be determined from the difference between the measured height and the surveyed height in block 714 and the offset may be stored, along with the pan and tilt angles, in block 716.

After analyzing each of the calibration points in block 706, a function may be determined in block 718 that represents the height offset of a measurement at each pan angle. In some systems, a tilt offset angle at a pan angle may be calculated rather than a height offset. Such a system may operate by measuring a height, comparing the measured height to a surveyed height, and then calculating the tilt angle offset. A function may be constructed to return a tilt angle offset for a given pan angle.

In many cases, several calibration points may be used. For example, a system may have six or more calibration points that may be distributed across the viewable area of the camera. The function may be constructed by regression analysis or other curve fitting technique.

A set of validation points may be identified in block 720. In many cases, the validation points may be similar to the calibration points, and may be surveyed to +/−1 cm or a similar accuracy. The validation points may be distributed across the viewable area of the camera and may be used to validate that the camera pan mechanism and the pan tilt offset function are correctly installed and calibrated.

For each validation point in block 722, a set of commands may be sent to the camera in block 724 to point to the validation point. In block 726, a height measurement may be taken using the pan tilt offset function. The actual surveyed height may be recalled in block 728 and an error may be determined in block 730.

The errors from the validation measurements may be summed or otherwise analyzed in block 732. If the error analysis shows an anomaly in block 734, an error may be detected in block 736. A manual analysis of the error may be performed in such a case. If the error analysis in block 734 may show that the calibration is satisfactory, the offset function may be used in block 738 for calibrated height measurements.

FIG. 8 is a flowchart illustration of an embodiment 800 showing a method of calibrating a video camera for zoom positioning. Embodiment 800 is a simplified example of a sequence that uses a set of calibration points to determine a function that defines an offset for specific zoom positions.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Many commercially available cameras with zoom features use a mechanical positioning system to move one or more lenses within the lens system. The mechanical positioning system may cause inaccuracies of where an image may be positioned in the field of view. For most uses of a camera, such inaccuracies may be unnoticeable or immaterial to the use case. However, a system that uses a video camera to take precise height measurements may incur errors due to inaccuracies in the zoom features of a lens. In the case of a vessel height measurement system with desired accuracies of +/−1 m at 6 km distance, the errors introduced by zoom lenses may be as high as +/−5 m or more at such distances.

The zoom calibration sequence of embodiment 800 may determine an offset to apply to a measurement taken at a given zoom factor. The calibration process may evaluate several calibration points and measure offsets for several zoom factors, then may generate a function representing an offset factor to apply to a given zoom factor.

The process may begin at block 802, and a calibration marker may be identified in block 804. The zoom may be set to maximum in block 806 and the pan and tilt may be adjusted so that the marker is in the center of the image in block 808.

The zoom may be decremented in block 810 and an offset from the center may be measured in block 812. The offset and zoom factor may be stored in block 814. If another zoom decrement is available in block 816, the process may return to block 810 to take another measurement at a new zoom factor.

When all zoom increments have been measured in block 816, a function may be generated that represents any offset factor for a measurement in block 818. The function may have an input of a zoom factor, and may return X and Y offsets for any measurement taken at the given zoom factor. The function may be applied to any measurement taken with the camera system, and each time the camera system may be upgraded, replaced, or recalibrated, the calibration routine of embodiment 800 may be performed.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

1. A method performed by at least one computer processor, said method comprising:
receiving an alert identifying a vessel, said alert comprising a position for said vessel;
determining a field of view of a video camera;
receiving a video feed from said video camera positioned in said field of view;
identifying a plurality of moving blobs within said video feed;
determining that a first moving blob corresponds with said position, said speed, and said movement direction for said vessel;
determining a highest pixel for said first moving blob; and
calculating a vessel height based on said highest pixel, said position, and said field of view.

2. The method of claim 1, said video camera being a fixed mounted video camera.

3. The method of claim 1, said video camera being a moveable video camera.

4. The method of claim 3 further comprising:
determining a desired field of view for said video camera, said desired field of view being determined at least in part from said position for said vessel;
causing said video camera to be positioned at said desired field of view, and using said desired field of view as said field of view.

5. The method of claim 4, said alert including a speed for said vessel, and a movement direction for said vessel, said method further comprising:
determining said desired field of view further using said speed and said movement direction, said desired field of view being determined to capture said vessel for a minimum amount of time of said video feed.

6. The method of claim 3 further comprising:
calibrating said moveable video camera by a calibration method comprising:
mounting said movable video camera on a fixed location with a pan system, said pan system being a computer-controllable pan system;
identifying a plurality of surveyed points within a total field of view of said movable video camera;
focusing said movable camera on a first surveyed point and collecting a first pan position;
determining a first pan angle offset for said first surveyed point;
focusing said movable camera on a second surveyed point and collecting a second pan position;
determining a second pan angle offset for said second surveyed point; and
determining a calibrated pan angle offset for a given pan position.

7. The method of claim 6, said calibration method further comprising:
focusing said movable camera on a third surveyed point and collecting a third pan position;
determining a third pan angle offset for said third surveyed point;
focusing said movable camera on a fourth surveyed point and collecting a fourth pan position;
determining a second pan angle offset for said second surveyed point; and
generating a pan angle offset function having a pan angle input and returning a pan angle offset.

8. The method of claim 1 further comprising:
monitoring said video feed at said field of view and determining a group of pixels that change over a plurality of frames; and
identifying said group of pixels as a moving blob.

9. The method of claim 8, said alert further comprising a speed for said vessel, and a movement direction for said vessel, said method further comprising:
determining an expected movement direction and expected speed for said first moving blob on said video feed from said position, said speed, and said movement direction of said vessel; and
comparing said expected movement direction and expected speed to a plurality of moving blobs to determine said first moving blob.

10. The method of claim 1 further comprising:
determining a tidal level corresponding to said video feed; and
determining an air draft measurement for said vessel using said tidal level.

11. The method of claim 1 further comprising:
determining that said vessel is approaching a restricted area; and
sending an intrusion alert for said restricted area.

12. The method of claim 1 further comprising:
determining a field of view for said video camera;
determining a mask for said field of view; and
as video is collected in said field of view, removing video in the area associated with said mask.

13. A system comprising:
at least one processor;
a video camera;
said at least one processor being configured to perform a method comprising:
receiving an alert identifying a vessel, said alert comprising a position for said vessel;
determining a field of view of said video camera;
receiving a video feed from said video camera positioned in said field of view;
identifying a plurality of moving blobs within said video feed;
determining that a first moving blob corresponds with said position, said speed, and said movement direction for said vessel;
determining a highest pixel for said first moving blob; and
calculating a vessel height based on said highest pixel, said position, and said field of view.

14. The system of claim 13, said video camera being a fixed mounted video camera.

15. The system of claim 13, said video camera being a moveable video camera.

16. The system of claim 15, said method further comprising:
determining a desired field of view for said video camera, said desired field of view being determined at least in part from said position for said vessel;
causing said video camera to be positioned at said desired field of view, and using said desired field of view as said field of view.

17. The system of claim 16, said alert including a speed for said vessel, and a movement direction for said vessel, said method further comprising:
determining said desired field of view further using said speed and said movement direction, said desired field of view being determined to capture said vessel for a minimum amount of time of said video feed.

18. The system of claim 15, said method further comprising:
calibrating said moveable video camera by a calibration method comprising:
mounting said movable video camera on a fixed location with a pan system, said pan system being a computer-controllable pan system;
identifying a plurality of surveyed points within a total field of view of said movable video camera;
focusing said movable camera on a first surveyed point and collecting a first pan position;
determining a first pan angle offset for said first surveyed point;
focusing said movable camera on a second surveyed point and collecting a second pan position;
determining a second pan angle offset for said second surveyed point; and
determining a calibrated pan angle offset for a given pan position.

19. The system of claim 18, said calibration method further comprising:
focusing said movable camera on a third surveyed point and collecting a third pan position;
determining a third pan angle offset for said third surveyed point;
focusing said movable camera on a fourth surveyed point and collecting a fourth pan position;
determining a second pan angle offset for said second surveyed point; and
generating a pan angle offset function having a pan angle input and returning a pan angle offset.

20. The system of claim 13 further comprising:
monitoring said video feed at said field of view and determining a group of pixels that change over a plurality of frames; and
identifying said group of pixels as a moving blob.

21. The system of claim 20, said alert further comprising a speed for said vessel, and a movement direction for said vessel, said method further comprising:
determining an expected movement direction and expected speed for said first moving blob on said video feed from said position, said speed, and said movement direction of said vessel; and
comparing said expected movement direction and expected speed to a plurality of moving blobs to determine said first moving blob.

22. The system of claim 13 further comprising:
determining a tidal level corresponding to said video feed; and
determining an air draft measurement for said vessel using said tidal level.

23. The system of claim 13 further comprising:
determining that said vessel is approaching a restricted area; and
sending an intrusion alert for said restricted area.

24. The system of claim 13 further comprising:
determining a field of view for said video camera;
determining a mask for said field of view; and
as video is collected in said field of view, removing video in the area associated with said mask.
